(19) United States
(12) Patent Application Publication
(10) Pub. No.: US 2009/0013364 A1
(43) Pub. Date: Jan. 8, 2009

(54) Digital broadcasting system and method for processing data

(75) Inventors: Jae Hyung Song, Seoul (KR); Jin Pil Kim, Seoul (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/213,885

(22) Filed: Jun. 25, 2008

(30) Foreign Application Priority Data
Jun. 27, 2007 (KR) 10-2007-0063659

(51) Int. Cl. H04N 7/173

(52) U.S. Cl. 725/110

(57) ABSTRACT

A broadcasting system and a method for processing data are disclosed. The broadcasting system receives a broadcasting signal including program table information including contents redistribution information, contents edition information and contents protection information and so on. The broadcasting system extracts the received information and stores the contents included in the broadcasting signal, outputs the contents to the outside, or outputs information of the contents in accordance with the extracted information.

This application claims the priority benefit of Korean Application No. 10-2007-0063659, filed on Jun. 27, 2007, which is hereby incorporated by reference as if fully set forth therein.

### BACKGROUND OF THE INVENTION

1. Field of the Invention

The present invention relates to a digital broadcasting system and a method for processing data.

2. Discussion of the Related Art

Users have experienced superiority in moving pictures of high definition (HD) and voice of Dolby digital owing to development of digital television (DTV) technique, and will encounter better advanced environment in the future owing to continuous development of a compression algorithm and high performance of hardware.

A digital television (DTV) can provide various additional services together with video and audio, which are unique functions of a television (TV). An example of the additional services includes an electronic program guide (EPG).

If a broadcasting station transmits transport packets, which include information related to various services, a receiver extracts information related to the services among various kinds of information included in the received transport packets. The receiver can display various kinds of information of a program on the screen based on the extracted information. According to another feature of digital broadcasting, it is easy to store, copy and redistribute the broadcasting program. However, the existing broadcasting system has a problem in that it fails to provide information as to storing, copying and redistribution of the broadcasting program.

### SUMMARY OF THE INVENTION

Accordingly, the present invention is directed to a broadcasting system and a method for processing data, which substantially obviate one or more problems due to limitations and disadvantages of the related art.

An object of the present invention is to provide a broadcasting system and a method for processing data, in which a digital broadcasting signal, which includes information of redistribution, contents protection and contents edition and so on, a method for processing the digital broadcasting signal, and a receiver are provided so as to provide a user with information of redistribution, contents protection and contents edition and so on.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, a method for processing data is disclosed herein. In the method, a broadcasting signal is received and program table information is demultiplexed from the broadcasting signal. The demultiplexed program table information is parsed. And at least one of contents protection information, contents redistribution information and contents editing information from the parsed program table information is extracted. The extracted information of the contents is outputted, the contents is outputted to the outside or the content is stored in accordance with the extracted information.

The contents protection information includes at least one of information as to whether contents can be recorded, information as to whether contents can be copied to the outside, and information of the number of copying times of contents.

The contents redistribution information includes at least one of information as to whether contents are redistributed, producer or copywriter information of contents, information of the number of redistribution times of contents, redistribution date information of contents, and redistributor information of contents.

The contents editing information includes at least one of information as to whether contents are edited, aspect ratio information of contents before editing, aspect ratio information of edited contents, information of the number of elementary streams included in contents before editing, type information of elementary streams included in contents before editing, language information of audio elementary streams included in contents before editing, surround mode information of audio elementary streams included in contents before editing, service mode information of audio elementary streams included in contents before editing, information of the number of channels of audio elementary streams included in contents before editing, information as to whether to provide full service of audio elementary streams included in contents before editing, duration information of contents before editing, duration information of edited contents, information of the number of rating regions (rating_region) of contents before editing, information of rated regions of contents before editing, information of rating dimension of contents before editing, rating information of contents before editing, and description information of rating of contents before editing.

In another aspect of the present invention, a digital broadcasting system comprises a receiver receiving a broadcasting signal, a demultiplexer demultiplexing program table information from the broadcasting signal, a data decoder parsing the demultiplexed program table information, a controller obtaining contents protection information from the program table information parsed by the data decoder and controlling whether to control contents included in the broadcasting signal in accordance with the contents protection information, a storage module storing the contents, and a storage controller controlling the storage module to store the contents in the storage module under the control of the controller.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a program map table (PMT) according to the embodiment of the present invention;

FIG. 2 illustrates an event information table (EIT) according to the embodiment of the present invention;

FIG. 3 illustrates a data event table (DET) according to the embodiment of the present invention;

FIG. 4 illustrates an example of syntax of “rc_descriptor” according to the embodiment of the present invention;

FIG. 5 illustrates an example of “external_copy_num” field value according to the embodiment of the present invention;

FIG. 6 illustrates an example of “content_edit” field value according to the embodiment of the present invention;

FIG. 7 schematically illustrates a configuration of a receiver according to the embodiment of the present invention;

FIG. 8 schematically illustrates a configuration of another receiver according to the embodiment of the present invention;

FIG. 9 is a flow chart schematically illustrating a procedure of processing contents protection information according to the embodiment of the present invention;

FIG. 10 is a flow chart schematically illustrating a procedure of processing contents redistribution information according to the embodiment of the present invention; and

FIG. 11 is a flow chart schematically illustrating a procedure of processing contents editing information according to the embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention relates to a digital broadcasting system and a method for processing data. A broadcasting signal can include information of storing, copying, editing, and redistribution of contents. In the present invention, a program and system information protocol (PSIP), which is the broadcasting information transfer standard for an advanced television systems committee (ATSC), will be described exemplarily to disclose the concept of the present invention.

A transmitting side encodes and transmits information related to storing, copying, editing and redistribution of contents in accordance with a moving picture experts group (MPEG). A receiving side receives and parses the information to provide various kinds of information of a program. Basically, the PSIP is a set of tables having a similar type and a similar object to program specific information (PSI) of the MPEG system. Each table can be divided into several sections and then can be transmitted. Also, the PSIP includes at least one descriptor in the table to provide additional information.

Program information including information of redistribution, content protection, content edition and so on, may be transmitted in a new PSIP table, or may be defined in a reserved field or a descriptor of an existing table. In the present invention, an example of extending and defining “rc_descriptor” among descriptors in the existing table will be described.

Hereinafter, (1) a digital broadcasting signal which includes information on redistribution, content protection, content edition and so on. (2) a system for processing the broadcasting signal, and (3) a method for processing the broadcasting signal will respectively be described.

(1) Digital broadcasting signal which includes information of redistribution, etc.

A redistribution control descriptor “rc_descriptor” includes information of redistribution provided by a provider of audio, video or data event. If the transmitting side transmits the “rc_descriptor” through terrestrial broadcasting, the “rc_descriptor” can be included in an event information table (EIT) and a program map table (PMT). In case of cable broadcasting, the “rc_descriptor” can be included in the PMT. If a cable broadcasting system transmits EIT, the “rc_descriptor” can be included in the EIT. In case of a data-only service of data broadcasting, the “rc_descriptor” can be included in a data event table (DET).

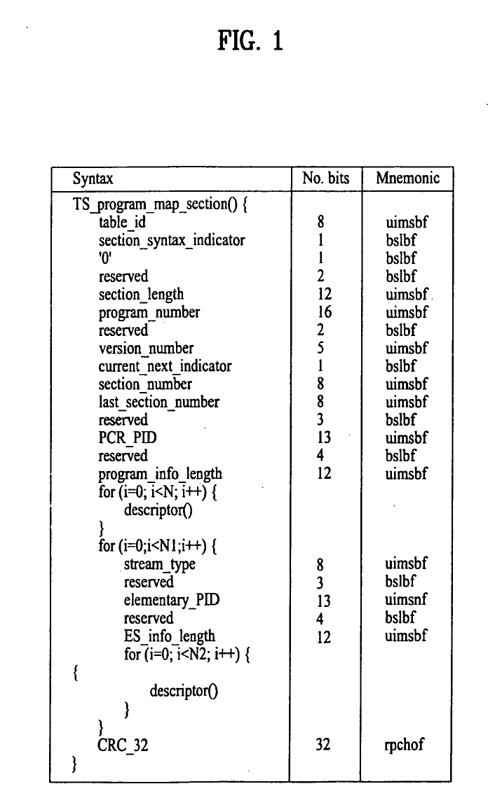

FIG. 1 illustrates a program map table (PMT) according to the embodiment of the present invention. The PMT provides mapping between elementary streams and a program number. The PMT is divided into one or more sections and then be transmitted.

Several fields constituting the table of FIG. 1 will be described as follows. Hereinafter, for brief and clear description, English expression of each field constituting syntax will be used as it is, and will be marked with double quotation marks.

“table_id” includes identification (ID) information of the PMT, and can have a value of ‘0x02.’ “program_id” includes information for identifying a program to which “program_map_PID” is applied. This field can be used to designate a broadcasting channel. “PCR_PID” includes packet ID (PID) information of a transport stream (TS) packet which includes a program clock reference (PCR) field, and “program_info_length” includes byte information of a next descriptor.

“stream_type” includes information for identifying a type of elementary streams transmitted to a packet, and “elementary_PID” includes PID information of a TS packet which transmits the elementary streams.

The aforementioned “rc_descriptor” can be included in a descriptor next to “program_info_length” in the table of FIG. 1. If the “rc_descriptor” is transmitted by being included in the PMT, the “rc_descriptor” can include redistribution information related to video, audio or data program identified by a “program_number” field.

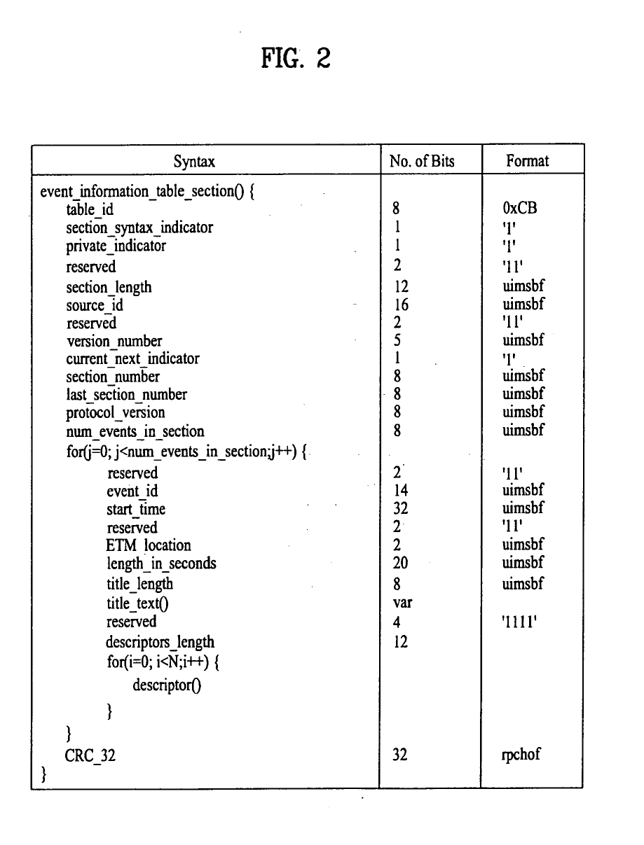

FIG. 2 illustrates an event information table (EIT) according to the embodiment of the present invention. The EIT includes information of events of a virtual channel defined therein.

Several fields constituting the table of FIG. 2 will be described as follows. Hereinafter, for brief and clear description, English expression of each field constituting syntax will be used as it is, and will be marked with double quotation marks.

“table_id” includes identification (ID) information of the EIT, and can have a value of ‘0xCB.’ “source_id” includes information for identifying a virtual channel which transmits events disclosed in this table. “num_events_in_section” represents the number of events included in the EIT section. “event_id” includes information for identifying event, “start_time” includes start time information of the event, “length_in_seconds” includes duration information of the event, and “title_text( )” includes title information of the title.

The “rc_descriptor” can be transmitted by being included in a descriptor of the table of FIG. 2. If the “rc_descriptor” is transmitted by being included in the EIT, the “rc_descriptor” can include redistribution information related to video, audio or data program identified by the “event_id” field.

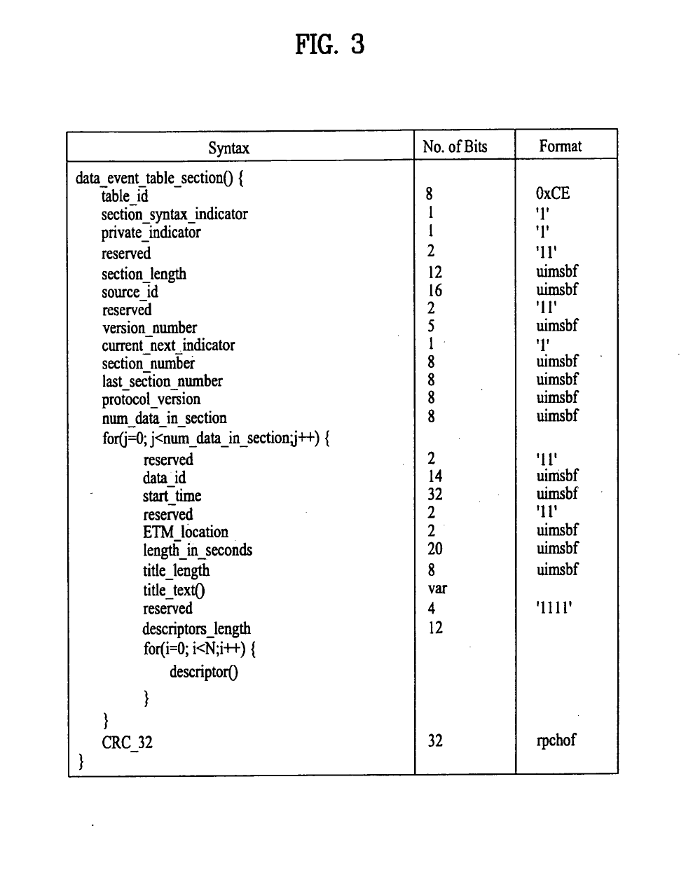

FIG. 3 illustrates a data event table (DET) according to the embodiment of the present invention. The DET includes information of data services of a virtual channel defined therein. This table includes information of three-hour unit.

Several fields constituting the table of FIG. 3 will be described as follows. Hereinafter, for brief and clear description, English expression of each field constituting syntax will be used as it is, and will be marked with double quotation marks.

“table_id” includes identification (ID) information of the EIT, and can have a value of ‘0xCE.’ “source_id” includes information for identifying a virtual channel which transmits events disclosed in this table. “num_data_in_section” represents the number of data events included in the DET section. “data_id” includes information for identifying data event, “start_time” includes start time information of the data event, “length_in_seconds” includes duration information of the data event, and “title_text ( )” includes title information of the data event.

The aforementioned “rc_descriptor” can be transmitted by being included in a descriptor of the table of FIG. 3. If the “rc_descriptor” is transmitted by being included in the DET, the “rc_descriptor” includes redistribution information related to data program identified by the “data_id” field.

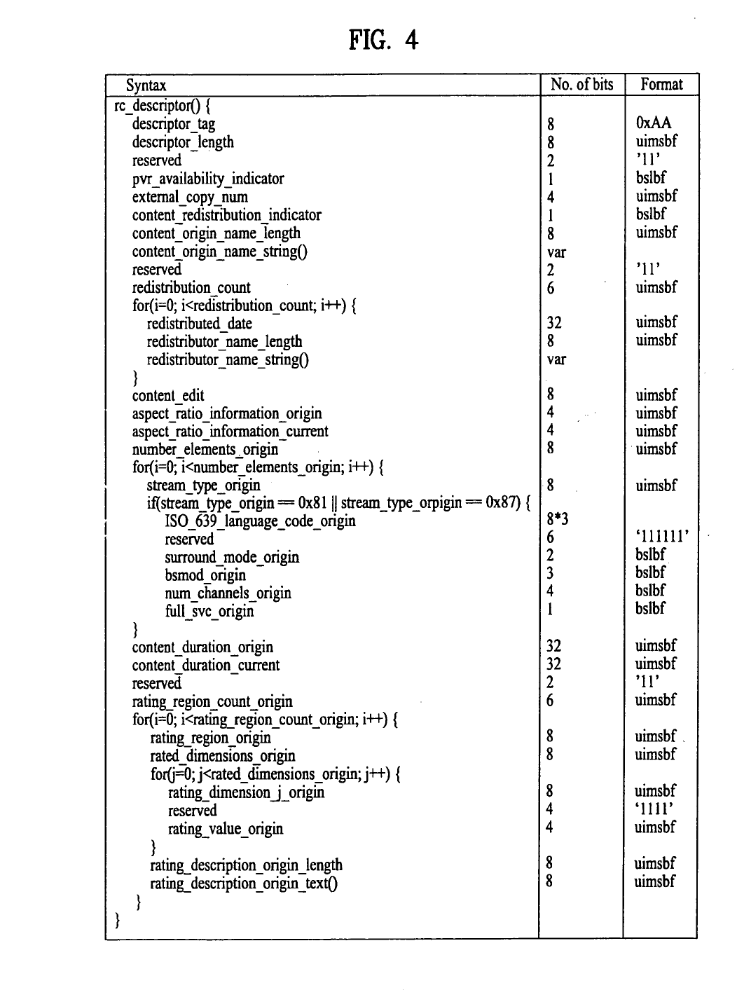

FIG. 4 illustrates an example of syntax of “rc_descriptor” according to the embodiment of the present invention. The “rc_descriptor” field includes contents protection information, contents redistribution information, contents editing information, etc. Hereinafter, each field of the descriptor will be described below.

“descriptor_tag” is an identification tag value of the descriptor, and can have a value of ‘0xAA.’ “descriptor_length” includes length information of the descriptor.

“pvr_availability_indicator” includes information as to whether contents can be stored. For example, if the field value is ‘true,’ the received contents can be stored in a storage unit like a personal video recorder (PVR).

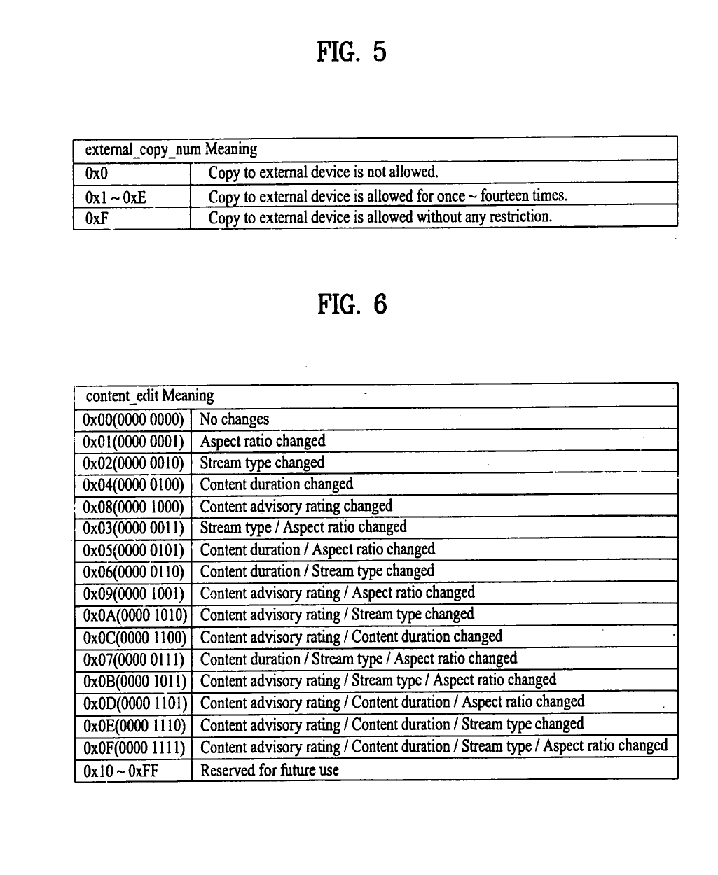

If the received contents are stored in the PVR, “external_copy_num” includes information as to whether the stored contents can be copied to an external device and information of the number of copying times. An example of external_copy_num is exemplarily illustrated in FIG. 5.

“content_redistribution_indicator” represents whether corresponding contents can be redistributed. For example, if the field value is ‘true,’ the corresponding contents represent redistributed contents.

“content_origin_name_length” represents length information of byte unit of ‘content_origin name_string( )’ field. “content_origin name_string( )” includes information of an original producer or copywriter of the corresponding contents.

“redistribution_count” includes count information of the number of redistribution times of the corresponding contents. “redistributed_date” includes information of redistribution date of the corresponding contents, “redistributor_name_length” represents length information of byte unit of the ‘redistributor_name_string( )’ field, and “redistributor_name_string( )” includes information of redistributor of the corresponding contents.

In addition to the exemplarily illustrated information, other information of a redistributor of current contents, which are redistributed, can be included in a VCT or EIT of the redistributed contents.

“content_edit” includes information as to whether to edit corresponding contents and information of edited contents. A detailed example of the “content_edit” field will exemplarily be illustrated in FIG. 6.

“aspect_ratio_information_origin” field includes information of a video aspect ratio of original contents before editing, and “aspect_ratio_information_current” includes information of a video aspect ratio of current contents.

“number_elements_origin” field includes information of the number of elementary streams included in the original contents before editing, and “stream_type_origin” includes type information of elementary streams included in the original contents before editing. The type information means a type of video/audio/data.

Stream type information of the edited current contents can be received by being included in the PMT or ‘service_location_descriptor’ of a VCT of contents, which are edited and redistributed.

“ISO_{—}639_language_code_origin” field includes language information of audio elementary streams included in the original contents before editing. This field is valid only if the elementary streams are identified as an audio elementary stream type by the “stream_type_origin” field. This field has the same value as that of the field included in the PMT and ‘service_location_descriptor( )’ of the elementary streams included in the contents before editing.

“surround_mode_origin” field includes information of a surround mode of the audio elementary streams included in the original contents before editing. “bsmod_origin” field includes information of a service mode of the audio elementary streams included in the original contents, “num_channels_origin” field includes information of the number of channels of the audio elementary streams included in the original contents, and “full_svc_origin” field includes information as to whether the audio elementary streams included in the original contents provides full service.

“surround_mode_origin”, “bsmod_origin”, “num_channels_origin”, and “full_svc_origin” fields are valid only if the element streams are identified as the audio elementary stream type by the “stream_type_origin” field. This field has the same value as that of the field included in ‘AC-3_audio_stream_descriptor( )’ of the elementary streams included in the contents before editing.

“content_duration_origin” field includes information of broadcasting time of the original contents before editing, and “content_duration_current” field includes information of broadcasting time of the edited current contents.

“rating_region_count_origin” field includes information of the number of ‘rating_regions’ where the original contents before editing are rated based on a rating region table (RRT) of the PSIP, and “rating_region_origin” field includes information of specific rated ‘rating_regions’ “rated_dimensions_origin” field includes information of the number of rated dimensions, and “rating_dimension_j_origin” field includes information of ‘rating_dimension’ where the original contents before editing are rated based on the RRT of the PSIP. “rating_value_origin” field represents information of ‘rating_value’ rated in the contents before editing.

“rating_description_origin_length” field represents length information of byte unit of the “rating_description_origin_text( )” field, and “rating_description_origin_text o” represents rating description rated in the contents before editing.

Since rating information of the edited current contents is received by being included in ‘content-advisory_descriptor’ of the EIT of the edited and redistributed contents, it is not included in the “rc_descriptor”.

Among fields constituting the “rc_descriptor” of FIG. 4, “pvr_availability_indicator” and “external_copy_num” fields are those related to contents protection information, and “content_redistribution_indicator”, “content_origin name_length”, “content_origin name_strings”, “redistribution_count”, “redistribution-date”, “redistributor_name_length”, and “redistributor_name_string( )” fields are those related to contents redistribution information.

Also, “content_edit”, “aspect_ratio information_origin”, “aspect_ratio_information_current”, “number_elements_origin”, “stream_type_origin”, “ISO_{—}639_language_code_origin”, “surround_mode_origin”, “bsmod_origin”, “num_channels_origin”, “full_svc_origin”, “content_duration_origin”, “content_duration_current”, “rating_region-count_origin”, “rating_region_origin”, “rated_dimensions_origin”, “rating_dimension_j_origin”, “rating_value_origin”, “rating_description_origin_length”, and “rating_description_origin_text( )” fields are those related to contents editing information.

Title of each field, its numerical value and its contents in FIG. 4 are examples. Fields other than the aforementioned fields can additionally be provided, and all the fields except for unnecessary fields can be transmitted if necessary. For example, only the fields related to contents protection information can be transmitted, or only the fields related to contents editing information can be transmitted. The example of the descriptor, which includes information of redistribution, etc. in accordance with the present invention, has been described exemplarily as above.

FIG. 5 illustrates an example of “external_copy_num” field value according to the embodiment of the present invention. In the example of FIG. 5, if a field value is equal to 0x0, copying to an external device is not allowed. If the field value is equal to 0xF, copying to the external device is allowed without any restriction. However, the field value is exemplarily described, and modification can be made in the field value.

FIG. 6 illustrates an example of “content_edit” field value according to the embodiment of the present invention. In the example of FIG. 6, examples of contents editing include editing of an aspect ratio, editing of stream type, editing of contents duration, and editing of contents advisory rating.

The “content_edit” field of FIG. 6 has 8 bits. Starting from the least significant bit (LSB), the first bit represents whether to edit the aspect ratio. The second bit represents whether to edit the stream type, the third bit represents whether to edit contents duration, and the fourth bit represents whether to edit contents rating. For example, if the “content_edit” field value of 8 bits is equal to ‘0000 0001’, the corresponding contents represent those of which aspect ratio has been edited from the original contents. If the “content_edit” field value of 8 bits is equal to ‘0000 0010’, the corresponding contents represent those of which stream type has been edited from the original contents. If the “content_edit” field value of 8 bits is equal to ‘0000 0100’, the corresponding contents represent those of which contents duration has been edited from the original contents.

If the “content_edit” field value of 8 bits is equal to ‘0000 1000’, the corresponding contents represent those of which contents rating has been edited from the original contents.

Furthermore, if the original contents are edited to one or more contents, combination can be made in the above values. For example, if the “content_edit” field value of 8 bits is equal to ‘0000 0101’, the corresponding contents represent those of which contents duration and aspect ratio have been edited from the original contents.

Edited contents in FIG. 6 are only exemplary, and other contents can be edited.

(2) Broadcasting System for Processing a Broadcasting Signal

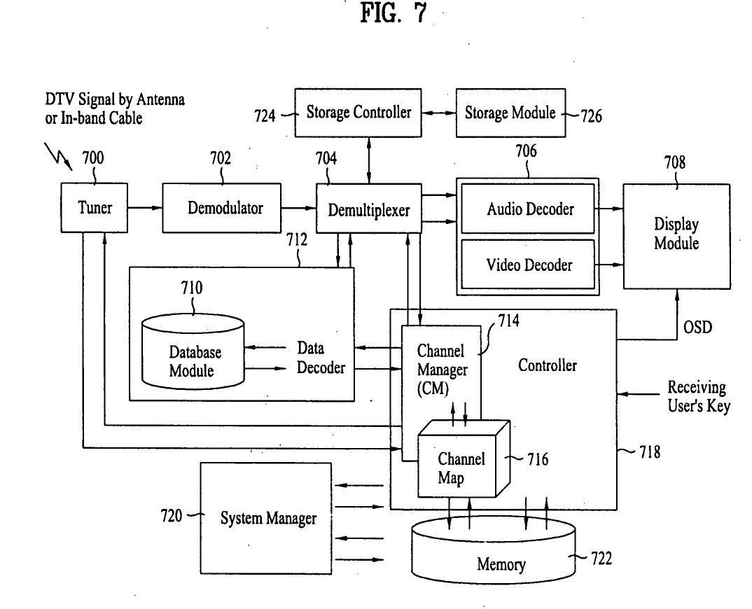

FIG. 7 schematically illustrates a configuration of a receiver according to the embodiment of the present invention. Hereinafter, a configuration of a digital broadcasting receiver, which receives a digital broadcasting signal to process the received digital broadcasting signal, will be described below, wherein the digital broadcasting signal includes the above information.

The digital broadcasting receiver which receives the digital broadcasting signal to process the signal includes a tuner 700, a demodulator 702, a demultiplexer 704, an A/V decoder 706, a display module 708, a database module 710, a data decoder 712, a channel manager (CM) 714, a channel map 716, a controller 718, a system manager 720, a memory 722, a storage controller 724, and a storage module 726.

The tuner 700 receives and tunes the digital broadcasting signal, which includes a PSI/PSIP table (program table information). The received PSI/PSIP table can include information of redistribution, etc. according to the present invention.

The demodulator 702 receives and demodulates the signal tuned by the tuner 700. The demultiplexer 704 demultiplexes transport packets demodulated by the demodulator 702 to audio, video and PSI/PSIP table data. If the data decoder 712 sets a packet identifier (PID) of a desired table, the demultiplexer 704 transmits sections of the PSI/PSIP table, which satisfies the PID from the received transport packets, to the data decoder 712. Also, the demultiplexer 704 demultiplexes A/V base streams and then transmits the demultiplexed A/V base streams to the A/V decoder 706. In other words, demultiplexing of the A/V data can be controlled by the channel manager 714, and demultiplexing of the PSI/PSIP table can be controlled by the data decoder 712.

The data decoder 712 parses the PSI/PSIP table section and analyzes various kinds of information included in the table. The information analyzed by the data decoder 712 is stored in the database module 710 and managed therein. The A/V decoder 706 decodes the received A/V data and outputs the decoded data to the display module 708.

At this time, the data decoder 712 decodes the section data part and stores the decoded data in the database module 710.

Also, the data decoder 712 controls demultiplexing of a system information table which is a channel and event related information table, and transmits A/V PID list to the channel manager 714.

The channel map 716 can store channel information among the information parsed by the data decoder 712 in a channel list type. The channel manager 714 can request the data decoder 712 to provide program table information with reference to the channel map 716, and receive the corresponding result. And, the channel manager 714 can control channel tuning of the tuner 700.

Furthermore, the channel manager 714 may control the A/V decoder 706 by controlling the demultiplexer 704 to directly set A/V PID. The A/V decoder 706 can respectively decode the demultiplexed audio and the demultiplexed video, and output them.

Meanwhile, the controller 718 performs a general function such as channel conversion. Namely, the controller 718 can drive a manager related to application or user interface (UI). If there is user's request to a receiving system, the controller 718 responds to the user's request by displaying the response on graphic user interface (GUI) through the screen. The user interface receives the user's request through an input module such as a remote controller, a key pad, a jog dial, and a touch screen on the screen, and then outputs the user's request to the controller 718.

Furthermore, the controller 718 controls the data decoder 712 and manages the channel map 716 by controlling the channel manager 714. The controller 718 stores GUI control of the receiving system, the user's request, and the status of the receiving system in the memory 722, and recovers them.

The system manager 720 controls booting of the receiving system through power-on and power-off, and stores ROM image (including downloaded software image) in the memory 722. The memory 722 stores an operation program of an operation system (OS), which is required for operation of the receiving system, and various kinds of application programs. The operation program and the application programs stored in the memory 722 can be updated or corrected to a new program which is downloaded.

The storage controller 724 interfaces with the demultiplexer 704 to control instant recording of data, reserved recording of data, time shift, etc. The data are stored in the storage module 726 under the control of the storage controller 724. If the data stored in the storage module 716 are needed to be played, the storage controller 724 reads out the corresponding data stored in the storage module 726 and outputs the data to the demultiplexer 704.

Furthermore, the storage controller 724 can control play of data, which are stored in the storage module 726 or currently buffered, fast forward, rewind, slow motion, instant replay, etc. Meanwhile, the storage controller 724 may store input data in the storage module 726 through scramble (or encryption) to prevent the input data from being illegally copied when the input data are stored in the storage module 716. Also, the storage controller 724 may store the data in the storage module 726 through compression encoding to provide efficiency of storage capacity.

If the broadcasting signal, which includes information of redistribution, etc., as described in FIG. 4, is received through the tuner 700, the demodulator 702 demodulates the received broadcasting signal and then outputs the demodulated signal to the demultiplexer 704.

The demultiplexer 704 demultiplexes the section, which includes the information of redistribution, etc., under the control of the data decoder 712, and transmits the demultiplexed data to the data decoder 712. As described above, the “rc_descriptor,” which includes information of redistribution, contents protection and contents edition and so on, can be included in the PMT and the EIT in case of terrestrial broadcasting. The “rc_descriptor” can be included in the PMT in case of cable broadcasting. If the PMT and EIT are transmitted in a cable broadcasting, the “rc_descriptor” can be included in the EIT. Also, in case of data broadcasting, the “rc_descriptor” can be included in the PMT and the DET.

The demultiplexer 704 demultiplexes the PMT, the DET, and the EIT to the data decoder 712 by using table identification information of the program table information. The data decoder 712 extracts the information included in the table by parsing the demultiplexed section, and stores the extracted information in the database module 710. The information included in the “rc_descriptor” is parsed, and then stored and managed in the database module 710.

The controller 718 can allow the information stored in the database module 710 to be displayed in the display module 708 in accordance with the user's request. The storage controller 724 controls whether to store contents data in the storage module 726, in accordance with contents protection information, which is stored in the database module 710 after being parsed. Also, the storage controller 724 controls whether to copy the contents data stored in the storage module 726 to the external device. Although not shown in FIG. 7, the embodiment of FIG. 7 can include interface where contents are input and output if the contents are copied into the external device in accordance with the contents related information exemplarily illustrated in FIG. 7.

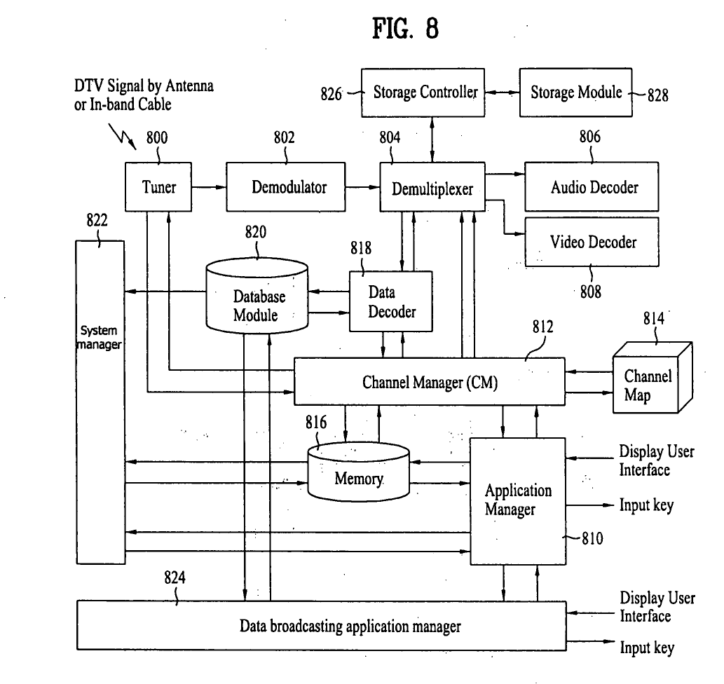

FIG. 8 schematically illustrates a configuration of another receiver according to the embodiment of the present invention.

Although FIG. 8 is similar to FIG. 7, FIG. 8 illustrates managers driven by the controller and communication relation among the managers in detail. Hereinafter, a configuration of a digital broadcast receiver, which receives a digital broadcasting signal to process the received digital broadcasting signal, will be described below, wherein the digital broadcasting signal includes the above information.

The digital broadcasting receiver which receives the digital broadcasting signal to process the signal includes a tuner 800, a demodulator 802, a demultiplexer 804, an audio decoder 806, a video decoder 808, an application manager 810, a channel manager 812, a channel map 814, a memory 816, a data decoder 818, a database module 820, a system manager 822, a data broadcasting application manager 824, a storage controller 826, and a storage module 828.

In FIG. 8, the same elements as those described in FIG. 7 have the same configuration as that of FIG. 7. The application manager 810, the channel manager 812, and the channel map 814 in FIG. 8 can correspond to the controller of FIG. 7, and the application manager 810, the system manager 822, and the data broadcasting application manager 824 can be driven by the controller.

The tuner 800 receives and tunes the digital broadcasting signal, which includes a PSI/PSIP table. The received PSI/PSIP table can include information of redistribution, etc. according to the present invention.

The demodulator 802 serves to receive and demodulate the signal tuned by the tuner 800. The demultiplexer 804 demultiplexes transport packets demodulated by the demodulator 802 to audio, video and PSI/PSIP table data.

If the data decoder 818 or channel manager 812 sets a packet identifier (PID) of a desired table, the demultiplexer 804 transmits sections of the PSI/PSIP table, which satisfies the PID from the received transport packets, to the data decoder 818. Also, the demultiplexer 804 demultiplexes A/V base streams and then transmits the demultiplexed A/V base streams to the audio decoder 806 and the video decoder 808. In other words, demultiplexing of the A/V data can be controlled by the channel manager 812, and demultiplexing of the PSI/PSIP table can be controlled by the data decoder 818.

The data decoder 818 parses the PSI/PSIP table section and analyzes various kinds of information included in the table. Also, the data decoder 818 can parse a data block transmitted by data carousel by parsing a digital storage media command and control (DSMCC) section. The information analyzed by the data decoder 818 is stored in the database module 820 and managed therein.

Furthermore, the data decoder 818 controls demultiplexing of a system information table which is a channel and event related information table, and transmits A/V PID list to the channel manager 812.

The channel manager 812 can request the data decoder 818 to provide program table information with reference to the channel map 814, and receive the corresponding result. And, the channel manager 812 can control channel tuning of the tuner 800.

Furthermore, the channel manager 812 may control the audio decoder 806 and the video decoder 808 by directly controlling the demultiplexer 804 to directly set A/V PID.

The application manger 810 performs a general function such as channel conversion. Namely, if there is user's request to a receiving system through user interface (UI), the application manager 810 responds to the user's request by displaying the user's request through graphic user interface (GUI) on the screen. The user interface receives the user's request through an input module such as a remote controller, a key pad, a jog dial, and a touch screen on the screen, and then outputs the user's request to the application manager 810 and the data broadcasting manager 824.

Furthermore, the application manager 810 controls the data decoder 818 and manages the channel map 814 by controlling the channel manager 812. The application manager 810 stores GUI control of the receiving system, the user's request, and the status of the receiving system in the memory 816, and recovers them.

The system manager 822 controls booting of the receiving system through power-on and power-off, and stores ROM image (including downloaded software image) in the memory 816. The memory 816 stores an operation program of an operation system (OS), which is required for operation of the receiving system, and various kinds of application programs. The operation program and the application programs stored in the memory 816 can be updated or corrected to a new program which is downloaded.

If there is a request of a data service by the user interface, the data broadcasting application manager 824 drives the corresponding application program stored in the memory 816 and processes the requested data to provide the user with the data service.

The storage controller 826 interfaces with the demultiplexer 804 to control instant recording of data, reserved recording of data, time shift, etc. The data are stored in the storage module 828 under the control of the storage controller 826. If the data stored in the storage module 828 are needed to be played, the storage controller 826 reads out the corresponding data stored in the storage module 828 and outputs the data to the demultiplexer 804.

Furthermore, the storage controller 826 can control play of data, which are stored in the storage module 828 or currently buffered, fast forward, rewind, slow motion, instant replay, etc. Meanwhile, the storage controller 826 may store input data in the storage module 828 through scramble (or encryption) to prevent the input data from being illegally copied when the input data are stored in the storage module 828. Also, the storage controller 826 may store the data in the storage module 828 through compression encoding to provide efficiency of storage capacity.

If the broadcasting signal, which includes information of redistribution, contents protection, contents edition and so on, as described in FIG. 4, is received through the tuner 800, the demodulator 802 demodulates the received broadcasting signal and then outputs the demodulated signal to the demultiplexer 804.

The demultiplexer 804 demultiplexes the section, which includes the information of redistribution, etc., under the control of the data decoder 818, and transmits the demultiplexed data to the data decoder 818. As described above, the “rc_descriptor,” which includes information of redistribution, etc., can be included in the PMT and the EIT in case of terrestrial broadcasting. The “rc_descriptor” can be included in the PMT in case of cable broadcasting. If the EIT is transmitted in cable broadcasting, the “rc_descriptor” can be included in the EIT. Also, in case of data broadcasting, the “rc_descriptor” can be included in the PMT and the DET.

The demultiplexer 804 demultiplexes the section corresponding to the table to the data decoder 818 by using table identification information. The data decoder 818 extracts the information included in the table by parsing the demultiplexed section, and stores the extracted information in the database module 820. The information included in the “rc_descriptor” is parsed, and then stored and managed in the database module 710.

The application manager 810 can allow the information stored in the database module 820 to be displayed in a display module (not shown) in accordance with the user's request. The storage controller 826 controls whether to store contents data in the storage module 828, in accordance with contents protection information, which is stored in the database module 820 after being parsed. Also, the storage controller 826 controls whether to copy the contents data stored in the storage module 828 to the external device.

(3) Data Processing Method for Processing a Broadcasting Signal

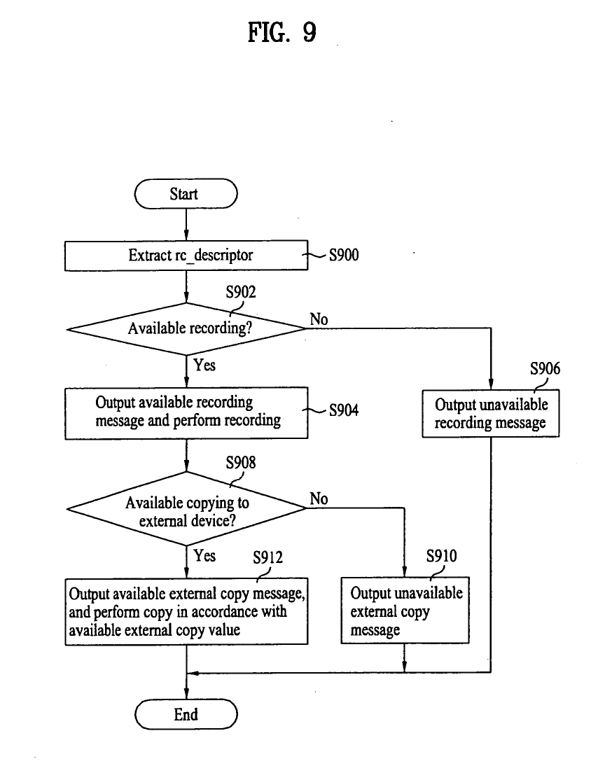

FIG. 9 is a flow chart schematically illustrating a procedure of processing contents protection information according to the embodiment of the present invention. FIG. 9 is a flow chart illustrating a procedure of processing contents protection information when the contents protection information is received by being included in “rc_descriptor.” Hereinafter, the procedure of processing contents protection information according to the present invention will be described with reference to the accompanying drawing.

A receiver extracts “rc_descriptor” included in the received broadcasting signal and analyzes information included in the descriptor (S900). As described above, the receiver can extract the descriptor by decoding the table section after filtering the section of the table which includes the descriptor.

The receiver determines whether corresponding contents can be recorded, by analyzing the descriptor (S902). For example, in case of the descriptor as illustrated in FIG. 4, the receiver can determine whether the corresponding contents can be recorded, through ‘pvr_availability_indicator’.

As a result of step S902, if the corresponding contents cannot be recorded, the receiver outputs an unavailable recording message and does not perform recording (S906). As a result of step S902, if the corresponding contents can be recorded, the receiver outputs an available recording message and performs recording in accordance with user's request (S904).

If the contents are recorded, the receiver determines whether to copy data of the recorded contents to the external device (S908). For example, in case of the descriptor as illustrated in FIG. 4, the receiver can obtain information as to whether the corresponding contents can be copied to the external device and information of the number of copying times through ‘external_copy_num’ field.

As a result of step S908, if the corresponding contents cannot be copied to the external device, the receiver outputs an unavailable external copy message and does not perform copying to the external device (S910). As a result of step S908, if the corresponding contents can be copied to the external device, the receiver outputs an available external copy message and performs copying to the external device in accordance with the user's request (S912). If there is limitation in the number of copying times, the receiver can perform copying as much as the limited number of times.

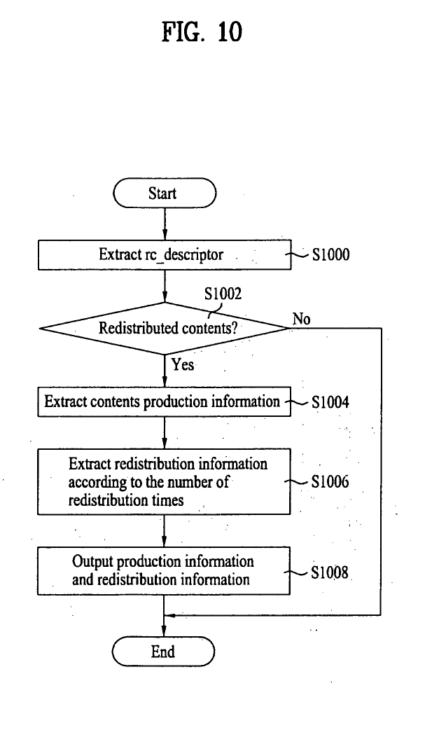

FIG. 10 is a flow chart schematically illustrating a procedure of processing contents redistribution information according to the embodiment of the present invention. FIG. 10 is a flow chart illustrating a procedure of processing contents redistribution information when the contents redistribution information is received by being included in “rc_descriptor.” Hereinafter, the procedure of processing contents redistribution information according to the present invention will be described with reference to the accompanying drawing.

A receiver extracts “rc_descriptor” included in the received broadcasting signal and analyzes information included in the descriptor (Sl000).

The receiver determines whether corresponding contents are redistributed contents, by analyzing the descriptor (S1002). For example, in case of the descriptor as illustrated in FIG. 4, the receiver can determine whether the corresponding contents are redistributed contents, through ‘content_redistribution_indicator’.

As a result of step S1002, if the corresponding contents are not redistributed, the receiver does not output information of redistribution and ends the procedure. As a result of step S1002, if the corresponding contents are redistributed contents, the receiver extracts original contents production information of contents (S1004). An example of the original contents production information includes information of a producer or copywriter. For example, in case of the descriptor as illustrated in FIG. 4, the receiver can obtain the information of original producer or copywriter through ‘content_origin_name_string( )’.

The receiver extracts redistribution information according to the number of redistribution times (Sl006). Examples of the redistribution information include the number of redistribution times, redistribution date, information of redistributor. For example, in case of the descriptor as illustrated in FIG. 4, the receiver can obtain the redistribution information through ‘redistribution_count’, ‘redistributed_date”, and ‘redistributor_name_string( )’.

The receiver outputs the extracted original contents production information or redistribution information on the screen in accordance with the user's request (S1008).

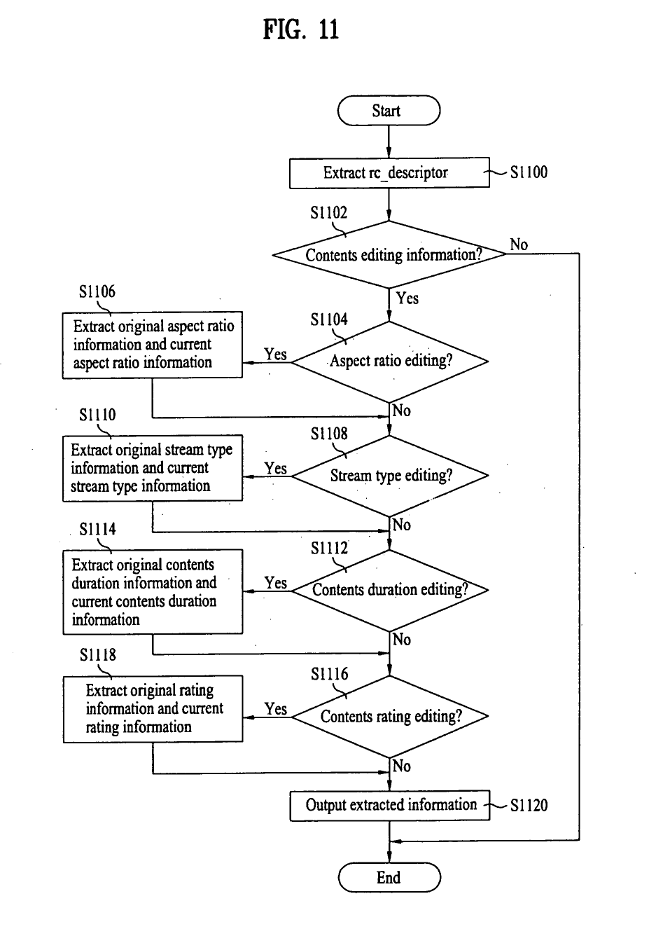

FIG. 11 is a flow chart schematically illustrating a procedure of processing contents editing information according to the embodiment of the present invention. FIG. 11 is a flow chart illustrating a procedure of processing contents redistribution information when the contents editing information is received by being included in “rc_descriptor.” Hereinafter, the procedure of processing contents editing information according to the present invention will be described with reference to the accompanying drawing.

A receiver extracts “rc_descriptor” included in the received broadcasting signal and analyzes information included in the descriptor (S1100).

The receiver determines whether corresponding contents are those edited from the original contents, by analyzing the descriptor (S1102). For example, in case of the descriptor as illustrated in FIG. 4, the receiver can determine whether the corresponding contents are edited contents, through ‘content_edit’.

As a result of step S1102, if the corresponding contents are not edited, the receiver does not output editing information and ends the procedure. As a result of step S1102, if the corresponding contents are edited contents, the receiver extracts editing contents information of the contents.

In the flow chart of FIG. 11, examples of editing contents include aspect ratio, stream type, contents duration, and content rating.

The receiver determines whether a screen aspect ratio of the received contents is edited with respect to the original contents (S1104). And the receiver extracts original aspect ratio information and edited aspect ratio information (S1106) and can edit the received contents by using the extracted information.

The receiver determines whether the stream type is edited (S1108), and extracts original stream type information and edited stream type information (Sl110). Also, the receiver can edit the received contents by using the extracted stream type information.

Also, The receiver determines whether contents duration is edited (S1112), and extracts original duration and edited duration (S1114). And the receiver can also edit the received contents by using the extracted contents duration information.

Additionally, the receiver determines whether contents rating is edited (S1116), and the receiver extracts original rating information.

For example, in case of the descriptor as illustrated in FIG. 4, the receiver can obtain the original aspect ratio information and the edited aspect ratio information from ‘aspect_ratio_information_origin’ and ‘aspect_ratio information_current’, and can obtain the original stream type information from ‘stream_type origin’. The receiver can obtain the edited stream type information from PMT or ‘service_location_descriptor’ within VCT of the edited contents.

The receiver can obtain the original contents duration and the edited contents duration from ‘content_duration_origin’ and ‘content_duration_current’, and can obtain the original rating information from ‘rating_region_origin’, ‘rating_dimension_j_origin’, and ‘rating_value_origin’. The receiver can obtain the edited rating information ‘content advisory descriptor’ provided from the EIT of the edited contents.

The receiver outputs the extracted information on the screen in accordance with the user's request (S1120).

As described above, the digital broadcasting signal which, includes information of redistribution, etc., the method for processing the signal, and the receiver for processing the signal according to the present invention have the following advantages.

First, it is possible to provide the user with various kinds of information of redistribution, etc. and manage the information.

In addition, since there is limitation in storing and copying broadcasting contents such as a broadcasting program by using the above information, it is possible to protect the contents and identify information as to whether to edit the contents and editing information.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for processing data, the method comprising:
receiving a broadcasting signal;
demultiplexing program table information from the broadcasting signal;
parsing the demultiplexed program table information; and
extracting at least one of contents protection information, contents redistribution information and contents editing information from the parsed program table information, and storing the contents included in the broadcasting signal in accordance with the extracted information, outputting the contents to the outside, or outputting information of the contents.

2. The method as claimed in claim 1, wherein the contents protection information includes at least one of information as to whether contents can be recorded, information as to whether contents can be copied to the outside, and information of the number of copying times of contents.

3. The method as claimed in claim 1, wherein the contents redistribution information includes at least one of information as to whether contents are redistributed, producer or copywriter information of contents, information of the number of redistribution times of contents, redistribution date information of contents, and redistributor information of contents.

4. The method as claimed in claim 1, wherein the contents editing information includes at least one of information as to whether contents are edited, aspect ratio information of contents before editing, aspect ratio information of edited contents, information of the number of elementary streams included in contents before editing, type information of elementary streams included in contents before editing, language information of audio elementary streams included in contents before editing, surround mode information of audio elementary streams included in contents before editing, service mode information of audio elementary streams included in contents before editing, information of the number of channels of audio elementary streams included in contents before editing, information as to whether to provide full service of audio elementary streams included in contents before editing, duration information of contents before editing, duration information of edited contents, information of the number of rating regions (rating_region) of contents before editing, information of rated regions of contents before editing, information of rating dimension of contents before editing, rating information of contents before editing, and description information of rating of contents before editing.

5. A digital broadcasting system comprising:
a receiver receiving a broadcasting signal;
a demultiplexer demultiplexing program table information from the broadcasting signal;
a data decoder parsing the demultiplexed program table information;
a controller obtaining contents protection information from the program table information parsed by the data decoder and controlling whether to control contents included in the broadcasting signal in accordance with the contents protection information;
a storage module storing the contents; and
a storage controller controlling the storage module to store the contents in the storage module under the control of the controller.

6. The digital broadcasting system as claimed in claim 5, further comprising an input and output interface outputting the contents stored in the storage module to the outside in accordance with the contents protection information.

7. The digital broadcasting system as claimed in claim 5, wherein the contents protection information includes at least one of information as to whether contents can be recorded, information as to whether contents can be copied to the outside, and information of the number of copying times of contents.

8. The digital broadcasting system as claimed in claim 5, wherein the data decoder further parses contents redistribution information from the program table information, and the digital broadcasting system further comprises an output module outputting the parsed contents redistribution information under the control of the controller.

9. The digital broadcasting system as claimed in claim 8, wherein the contents redistribution information includes at least one of information as to whether contents are redistributed, producer or copywriter information of contents, information of the number of redistribution times of contents, redistribution date information of contents, and redistributor information of contents.

10. The digital broadcasting system as claimed in claim 5, wherein the data decoder further parses contents editing information from the program table information, and the digital broadcasting system further comprises an output module outputting the parsed contents editing information under the control of the controller.

11. The digital broadcasting system as claimed in claim 10, wherein the contents editing information includes at least one of information as to whether contents are edited, aspect ratio information of contents before editing, aspect ratio information of edited contents, information of the number of elementary streams included in contents before editing, type information of elementary streams included in contents before editing, language information of audio elementary streams included in contents before editing, surround mode information of audio elementary streams included in contents before editing, service mode information of audio elementary streams included in contents before editing, information of the number of channels of audio elementary streams included in contents before editing, information as to whether to provide full service of audio elementary streams included in contents before editing, duration information of contents before editing, duration information of edited contents, information of the number of rating regions (rating_region) of contents before editing, information of rated regions of contents before editing, information of rating dimension of contents before editing, rating information of contents before editing, and description information of rating of contents before editing.
